(19) United States
(12) Patent Application Publication
(10) Pub. No.: US 2015/0176476 A1
(43) Pub. Date: Jun. 25, 2015

(54) SYSTEM FOR CHARGE AIR COOLING AND ASSOCIATED METHOD FOR PROVIDING CHARGE AIR COOLING FOR AN INTERNAL COMBUSTION ENGINE

(71) Applicant: BEHR GMBH & CO. KG, Stuttgart (DE)

(72) Inventors: Johannes Diem, Weissach (DE); Mark Schienemann, Remseck (DE); Matthias Fehrenbach, Stuttgart (DE)

(73) Assignee: BEHR GMBH & CO. KG, Stuttgart (DE)

(21) Appl. No.: 14/416,715

(22) PCT Filed: Jul. 22, 2013
(86) PCT No.: PCT/EP2013/065437

§ 371 Date: Jan. 23, 2015

(30) Foreign Application Priority Data
Jul. 23, 2012 (DE) 10 2012 212 867.0

(51) Int. Cl. F02B 29/04

(52) U.S. Cl. CPC F02B 29/0406

(57) ABSTRACT

The invention relates to a system for charge air cooling for an internal combustion engine based on an engine family, wherein an intake module is arranged between a throttle valve and a combustion chamber. A first cooling device of the system is shaped to be structurally integrated into the intake module. Furthermore, in accordance with the system, a second cooling device is available, which supplements the first cooling device and which is designed to pre-cool charge air before said charge air enters the intake module and which is adapted for use with at least one engine model of the engine family. The second cooling device is intended for top engine types and can be arranged between the throttle valve and a charge air compressor.

### TECHNICAL FIELD

The invention relates to a system for charge-air cooling for an internal combustion engine based on an engine family, as per the preamble of claim 1. The invention also relates to an associated method for providing charge-air cooling, as per the preamble of claim 7. The invention also relates to an internal combustion engine having a charge-air compression unit, and to a motor vehicle having an internal combustion engine.

### PRIOR ART

In modern vehicle and engine families, the standardization of components is of ever-increasing importance. In particular, for the charge-air cooling of the individual engine variants or engine models, it is necessary to use as far as possible the same charge-air coolers, but these must be capable of dealing with very broad ranges of heat output. For top-end engine specifications, levels of heat output may be generated which, with regard to the charge-air cooling arrangement, can no longer be cooled exclusively by means of the low-pressure cooler but require precooling by the engine high-temperature (HT) cooling circuit.

The laid-open specification DE102010011373A1 describes a charge-air cooling arrangement for an internal combustion engine in which two charge-air coolers for cascaded charge-air cooling are integrated, as high-temperature (HT) and low-temperature (LT) coolers, in the intake pipe or an intake module of the respective intake tract.

Such cascaded charge-air cooling with two coolers (HT cooler and LT cooler) integrated in the intake pipe is however an expensive application because it must be developed exclusively for the top-end engine specification, and it may be the case that the intake pipe cannot also be used for lower engine specifications owing to requirements with regard to structural space and the elimination of dead volumes.

Furthermore, the high charge pressures in combination with high temperatures of the highly charged engines have the effect that, to some extent, the throttle flaps must be cooled and plastics material is not adequate for the intake pipes with integrated charge-air coolers for strength reasons, and aluminum intake pipes, for example, must therefore be used. This leads altogether to even higher costs.

### Presentation of the Invention, Problem, Solution, Advantages

It is an object of the invention to provide inexpensive charge-air cooling for entire engine families. In particular, the charge-air cooling should permit the use of standardized components.

This is achieved by means of the features of claim 1, whereby a system for charge-air cooling for an internal combustion engine based on an engine family is created. For this purpose, a first cooling device of the system is designed to be structurally integrated into an intake module arranged between a throttle flap and a combustion chamber. Furthermore, in the system, a second cooling device is provided which can be arranged between the throttle flap and a charge-air compressor and which can supplement the first cooling device and which is designed to precool charge air before it enters the intake module. The second cooling device is provided for use with at least one engine model of the engine family.

Also provided according to the invention is a method for providing charge-air cooling for motor vehicles with an internal combustion engine, in which method, for charge-air cooling for an entire engine family, use is made of a system that can be adapted for multi-stage, preferably two-stage, charge-air cooling. In this case, regardless of the respective engine model of the engine family, a first cooling device is arranged in an intake module arranged between a throttle flap and a combustion chamber. In the case of one or more engine models of the engine family, a second cooling device is additionally arranged between the throttle flap and a charge-air compressor, such that precooling of charge air before it enters the intake module can be performed there in the relevant engine models.

Thus, a combination of charge-air cooling arrangements is created which is specially configured for use with the various engine types or engine models of an engine family. Accordingly, one aspect of the combination according to the invention is a base solution for an engine family, with a first cooling device as a charge-air cooling means integrated in the intake pipe being used as a starting point. The base solution expediently yields a technical advantage in particular for the engines in the “normal” performance spectrum, such as short response time owing to a small volume in the charge-air path, low pressure loss and high power-to-weight ratio.

At the same time, the solution according to the invention provides for the use of a second cooling device as a further charge-air cooler component, referred to in descriptive terms as a so-called “add-on” cooler upstream of the integrated charge-air cooler, for a number of engine types. For the high-end engine specifications and top-end engine specifications, it is thus expediently the case that cascaded charge-air cooling is implemented, such that the first cooling device is prevented from exceeding a power limit. Otherwise, it would for example be possible for the first cooling device to encounter situations in which the charge-air cooling power can no longer be output to the surroundings without the need for greatly increasing the temperature level. To express this more specifically with regard to orders of magnitude, a cooling performance of for example 30 kW in the LT circuit can be regarded as a power limit with regard to the base solution.

An advantage of the invention is that, by contrast to, for example, conventional cascaded cooling with two coolers in the intake pipe for a top-end engine specification or the use of different intake pipes for an engine family, it is made possible here for standardized components for charge-air cooling to be used for all of the engines of an engine family, and for costs to thus be reduced.

In particular, only low application costs or reduced application costs are incurred for the low unit quantities for top-end engine specifications. Furthermore, an unnecessary structural space requirement can be avoided in particular for low engine specifications. It is thus also made possible for the intake pipe of an engine family to always remain the same regardless of the supercharging situation.

Furthermore, the throttle flap can, in a cost-saving manner, be operated without cooling, and thus a standard component can be used. The use of plastic for the intake pipe with integrated charge-air cooler is advantageously made possible for all engine variants, instead of the use of, for example, aluminum or expensive temperature-resistant plastics for the intake pipe housing.

In other words, for the engine family, the charge-air cooling for low levels of supercharging can be realized by means of a standardized charge-air cooler component, ideally in the standardized intake pipe, and it is merely necessary to implement the additional precooler for the top-end engine specifications. With regard to structural space, only that for the additional precooler must be kept free for the top-end engine specification.

In one advantageous embodiment of the invention, the intake module is in the form of an intake pipe within which the first cooling device is arranged as an indirect cooler.

It is preferable, with regard to the base solution, if the first cooling device is coupled to an internal combustion engine, the design of the first cooling device and dimensioning of the internal combustion engine being such that the first cooling device can, without the use of the second cooling device, provide a level of cooling power required for cooling charge air compressed by the charge-air compressor during normal operation of the internal combustion engine.

Furthermore, with regard to the supplementary solution discussed above, the second cooling device is used for precooling and, for this purpose, is preferably integrated into the charge-air line.

In one embodiment of the invention, the internal combustion engine has an engine cooling circuit, wherein the second cooling device is connected in series or parallel with respect to the internal combustion engine.

In another embodiment, the second cooling device is designed as a direct charge-air cooler, in particular as a direct charge-air cooler which is cooled by ambient air.

It is thus possible according to the invention for the waste heat to be released either to the engine coolant or, depending on the application, directly to the ambient air. In the embodiment with a direct charge-air cooler, the precooling may take place for example in a wheel arch or in both wheel arches or in a cooling module arranged in the front end of the vehicle.

The invention may be used for exhaust-gas charge-air cooling and/or for fresh charge-air cooling.

In one refinement of the invention, the second cooling device is used for cooling the charge air to below a predetermined threshold value, such that an upper temperature limit of, for example, 150° C. is adhered to. It is thus reliably achieved that the maximum charge-air temperature, which after the precooling in the intake pipe is accordingly likewise lower, for example <150° C., which significantly lessens the demands on the plastics intake pipe material with regard to strength.

With this refinement of the invention, it can be achieved that, in particular, the intake pipe no longer needs to withstand 230° C. and 3.5 bar absolute and instead only needs to withstand 40° C. and 3.4 bar absolute. The temperature reduction is a considerable factor for the durability and the use of inexpensive plastics.

It is also achieved in a particularly simple and defined manner that the throttle flap between the two charge-air coolers is subjected not to the maximum charge-air temperatures but only to the restricted charge-air temperatures downstream of the HT charge-air cooler. Throttle flaps are nowadays already used in series-produced vehicles at temperatures <150° C., and are considerably less expensive than variants with throttle flap cooling.

According to one aspect of the invention, there is also provided an internal combustion engine having a charge-air compression unit, which internal combustion engine is based on an engine family and in which internal combustion engine a first cooling device for charge-air cooling is arranged in the intake tract downstream of a throttle flap. Here, it is furthermore the case in the internal combustion engine that a second cooling device for precooling the charge air is arranged upstream of the throttle flap and preferably downstream of a charge-air compressor.

Also provided is a motor vehicle having an internal combustion engine, which motor vehicle is designed such that, for charge-air cooling of the internal combustion engine, the system according to the invention is used, wherein the internal combustion engine has the first cooling device and/or the first cooling device and the second cooling device of the system.

Further advantageous refinements are described by the following description of the figures and by the subclaims.

### BRIEF DESCRIPTION OF THE DRAWINGS

Below, the invention will be explained in more detail on the basis of at least one embodiment and with reference to the drawings, in which:

FIG. 1 shows a first embodiment of an arrangement according to the invention of an internal combustion engine with charge-air cooling according to the basic solution of the invention,

FIG. 2 shows another embodiment of an arrangement according to the invention of an internal combustion engine with indirect charge-air precooling, and

FIG. 3 shows yet another embodiment of the arrangement according to the invention of an internal combustion engine with direct charge-air precooling.

### PREFFERED EMBODIMENT OF THE INVENTION

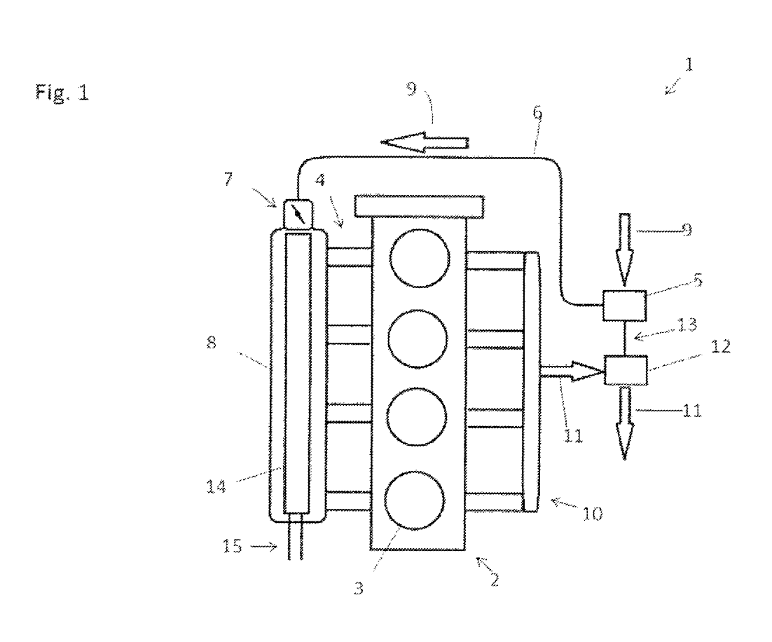

FIG. 1 shows a first embodiment of an arrangement 1 according to the invention of an internal combustion engine 2 with charge-air cooling according to the aspect of the basic solution according to the invention. The internal combustion engine 2 comprises in this case four cylinders or four combustion chambers 3. Intake air is supplied to the combustion chambers 3 through an intake tract. In FIG. 1, the intake manifolds are denoted by the reference sign 4. The internal combustion engine is connected to a charge-air compressor 5. After the compression, the charge air is conducted onward via the charge-air line 6 and supplied via a throttle flap 7 to an intake pipe 8 connected upstream of the intake manifolds 4. The flow of the charge air or of the intake air in the intake tract is indicated in FIG. 1 by arrows 9. After the combustion, the exhaust gases are conducted to a turbocharger turbine 12 via an exhaust system 10 composed of exhaust pipes and exhaust manifolds. The exhaust-gas flow is likewise indicated by arrows 11. The turbocharger turbine 12 drives the charge-air compressor 5 via a shaft 13.

As shown in FIG. 1, the first cooling device 14 according to the invention is structurally integrated into the intake pipe 8. The first cooling device 14 and the intake pipe 8 may be standardized components. Also, the first cooling device 14 and the intake pipe are dimensioned relative to one another and with regard to the engine 2 such that the throttle flap 7 does not require additional cooling and can be designed as a standard component. An LT cooler can thus be implemented by means of the first cooling device 14.

The first cooling device 14 is in this case designed as an indirect cooler. Here, the reference sign 15 denotes an inlet and an outlet for coolant of the first cooling device. The charge air flows into the intake pipe 8 via the throttle flap 7 as hot exhaust gas and/or as a mixture heated by the compression process, and flows around the first cooling device 14, such that the charge air is cooled before it passes over into the intake pipes 4.

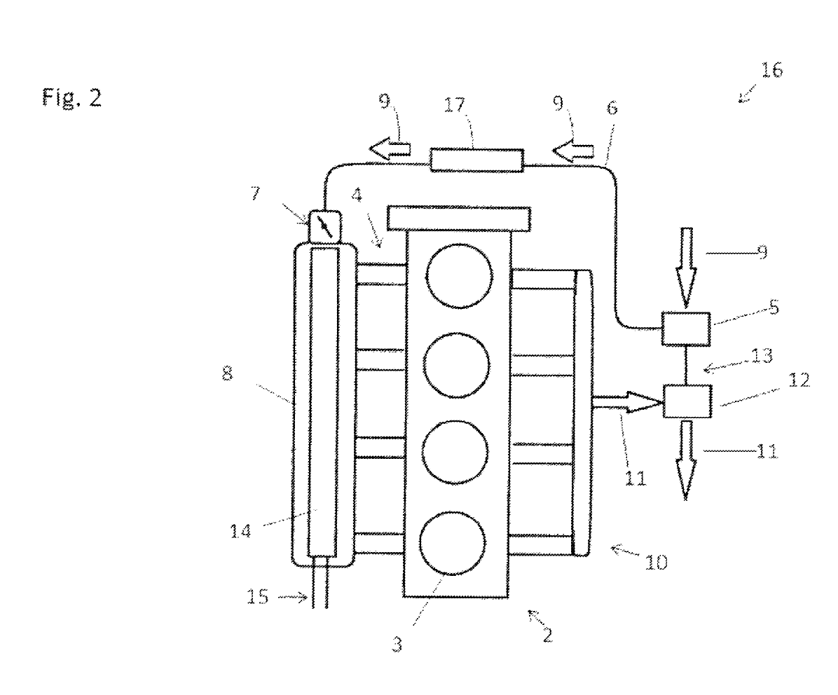

FIG. 2 shows another embodiment of an arrangement 16 according to the invention of an internal combustion engine 2 with indirect charge-air precooling. FIG. 2 shows the measures according to the invention in conjunction with an engine of relatively high power, in particular for the top-end engine specifications of an engine family. As can be seen from a comparison of FIGS. 1 and 2, the same components as those used in FIG. 1 can likewise be used in the embodiment in FIG. 2. In this case, the components such as the intake pipe 8 and the first cooling device 14 may preferably be standard components, which in particular yields a cost saving. By contrast to FIG. 1, it is the case here for the top-end engine specification that a second cooling device 17 is arranged upstream of the throttle flap. Thus, with the first cooling device 14 and the second cooling device 17, charge-air cooling with an LT cooler and an HT cooler is realized in a particularly expedient manner. The second cooling device 17 serves for precooling and is in this case designed as an indirect cooler.

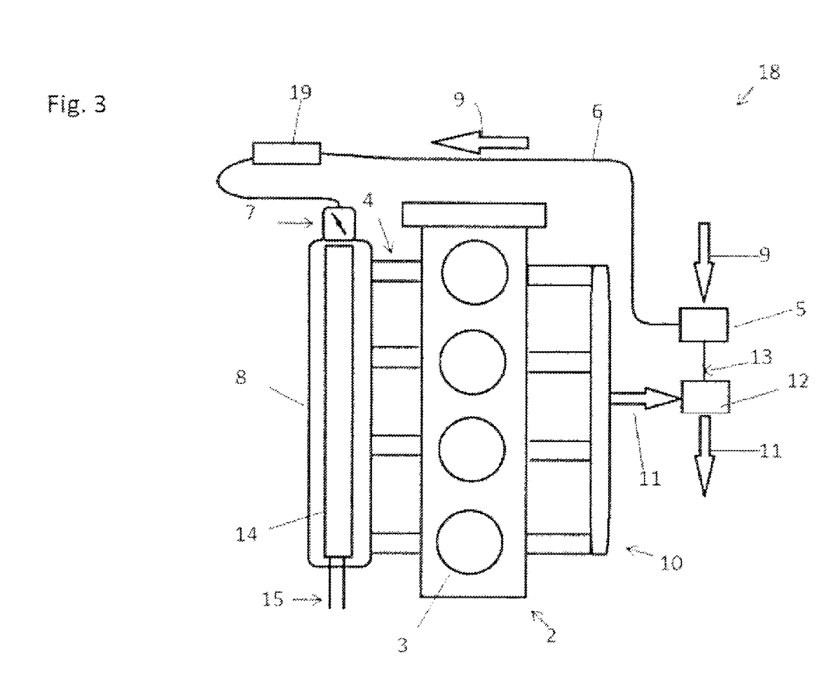

FIG. 3 shows yet another embodiment of the arrangement 18 according to the invention of an internal combustion engine 2 with charge-air cooling. By contrast to the variant as per FIG. 2, use is made in this case of a second cooling device 19 with direct charge-air precooling. In this case, the charge-air precooling can be realized using ambient air or relative wind in the wheel arch, in the front-end section or at other suitable locations on the vehicle.

1. A system for charge-air cooling for an internal combustion engine which is based on an engine family and in which an intake module is arranged between a throttle flap and a combustion chamber, wherein a first cooling device of the system is designed to be structurally integrated into the intake module, and in which a charge-air line is arranged between a charge-air compressor and the throttle flap, wherein, in the system, a second cooling device is provided which supplements the first cooling device, is designed to precool charge air before it enters the intake module and is adapted for use with at least one engine model of the engine family, which second cooling device can be arranged between the throttle flap and the charge-air compressor.

2. The system as claimed in claim 1, wherein the intake module is in the form of an intake pipe within which the first cooling device is arranged as an indirect cooler.

3. The system as claimed in claim 1, wherein the first cooling device is arranged in a motor vehicle and coupled to an internal combustion engine, the design of the first cooling device and dimensioning of the internal combustion engine being such that the first cooling device can, without the use of the second cooling device, provide a level of cooling power required for cooling charge air compressed by the charge-air compressor during normal operation of the internal combustion engine.

4. The system as claimed in claim 1, wherein the second cooling device is used for precooling and, for this purpose, is integrated into the charge-air line.

5. The system as claimed in claim 1, wherein the internal combustion engine has an engine cooling circuit in which the second cooling device is connected in series or parallel with respect to the internal combustion engine.

6. The system as claimed in claim 1, wherein the second cooling device is designed as a direct charge-air cooler, in particular as a direct charge-air cooler which is cooled by ambient air.

7. A method for providing charge-air cooling for motor vehicles with an internal combustion engine, wherein, for charge-air cooling for an engine family, use is made of a system that can be adapted for multi-stage, preferably two-stage, charge-air cooling, wherein, regardless of the respective engine model of the engine family, a first cooling device is arranged in an intake module arranged between a throttle flap and a combustion chamber, and in the case of one or more engine models of the engine family, a second cooling device is additionally arranged between the throttle flap and a charge-air compressor, such that precooling of charge air before it enters the intake module can be performed there.

8. The method for providing charge-air cooling as claimed in claim 7, wherein the system for charge-air cooling for an internal combustion engine which is based on an engine family and in which an intake module is arranged between a throttle flap and a combustion chamber, wherein a first cooling device of the system is designed to be structurally integrated into the intake module, and in which a charge-air line is arranged between a charge-air compressor and the throttle flap, wherein, in the system, a second cooling device is provided which supplements the first cooling device, is designed to precool charge air before it enters the intake module and is adapted for use with at least one engine model of the engine family, which second cooling device can be arranged between the throttle flap and the charge-air compressor, is used for exhaust-gas charge-air cooling and/or fresh charge-air cooling and/or the second cooling device is used for cooling the charge air to below a predetermined threshold value such as, for example, 150° C.

9. An internal combustion engine having a charge-air compression unit, which internal combustion engine is based on an engine family and in which internal combustion engine a first cooling device for charge-air cooling is arranged in the intake tract downstream of a throttle flap, wherein, furthermore, a second cooling device for precooling the charge air is arranged upstream of the throttle flap and preferably downstream of a charge-air compressor.

10. A motor vehicle having an internal combustion engine, which motor vehicle is designed such that, for charge-air cooling of the internal combustion engine, the system as claimed in claim 1 is used in the motor vehicle, wherein the internal combustion engine has the first cooling device and/or the first cooling device and the second cooling device of the system, or in which motor vehicle the internal combustion engine is designed as per the internal combustion engine having a charge-air compression unit, which internal combustion engine is based on an engine family and in which internal combustion engine a first cooling device for charge-air cooling is arranged in the intake tract downstream of a throttle flap, wherein, furthermore, a second cooling device for precooling the charge air is arranged upstream of the throttle flap and preferably downstream of a charge-air compressor.
